(19) United States
(12) Patent Application Publication
(10) Pub. No.: US 2015/0169796 A1
(43) Pub. Date: Jun. 18, 2015

(54) Piping or Wiring Support Device

(71) Applicants: Masatake Sato, Tokyo (JP); Koji Shiroyama, Tokyo (JP)

(72) Inventors: Masatake Sato, Tokyo (JP); Koji Shiroyama, Tokyo (JP)

(73) Assignee: Hitachi, Ltd., Chiyoda-ku, Tokyo (JP)

(21) Appl. No.: 14/400,998

(22) PCT Filed: May 14, 2012
(86) PCT No.: PCT/JP2012/003117

§ 371 Date: Dec. 30, 2014

(51) Int. Cl. G06F 17/50

(52) U.S. Cl. CPC G06F 17/509

(57) ABSTRACT

It is intended to provide a function to quickly generate a piping route shape reflecting the design intention even if layout conditions are complicated. It is a piping or wiring support device having a routing difficulty level calculating function to output a scalar field, which is space weight information numerically expressing how the difficulty level of routing by the route search space of route search space parameter memory means is affected by the obstacle shape of obstacle shape memory means; and a route shape generation function to output a route passing point sequence of the route by figuring out the route shape in the route search space from the start point to the end route of the route by using the outputted scalar field.

### TECHNICAL FIELD

The present invention relates to piping, wiring and other three-dimensional route shape designing that uses CAD.

### BACKGROUND ART

Along with the enhancement of processing capacities of computers in recent years, 3D-CAD has come into use in plant designing. As a result, arrangement of layouts of various plant component items including plant equipment, piping, ducts and cable trays has come to be studied on 3D-CAD. Especially for plant piping, it is important to design a route that satisfies design conditions and minimizes the cost while taking avoidance of interference with plant equipment and body into account, and the introduction of 3D-CAD can be expected to bring about more advance layout designing. On the other hand, the increased freedom of route shape designing tends to entail greater complexity of modeling work and a consequent increase in designing man-hours. In order to reduce the man-hours taken for layout designing, Japanese Unexamined Patent Application Publication No. 2002-288250 for instance discloses a method of automatically generating the optimal piping route shape satisfying a certain set of designing rules by using a genetic algorithm. Further, Japanese Unexamined Patent Application Publication No. Hei06-068188 discloses a method of easily deforming the route shape while keeping the continuity of the piping route when partially editing a three-dimensional route already prepared. Further, Japanese Unexamined Patent Application Publication No. 2002-149723 discloses, regarding a method to support optimization of routes between components, performance of labeling from a starting point S to an ending point T by the MAZE method and calculation of weighted evaluation functions of design solution candidates, but it is difficult to judge from labeling numerical values what kind of deigning rules are applied.

### CITATION LIST

### Patent Literature

### Patent Literature 1: Japanese Unexamined Patent Application Publication No. 2002-288250

Patent Literature 2: Japanese Unexamined Patent Application Publication No. Hei06-068188

### Patent Literature 3: Japanese Unexamined Patent Application Publication No. 2002-149723

### SUMMARY OF INVENTION

### Technical Problem

When a piping route shape was designed fully automatically, in many cases discrepancy occurred between the designer's design intention and the result of automatic designing. In such a case the designer had to conduct editing after inferring back from the route shape and grasping what kind of design rule was applied in what part of the route shape, resulting in a disadvantage of difficulty to update the difference by manual editing.

Also in manual editing of a piping route shape, there was a problem of limitation of the freedom of deforming the route shape when the congestion of the space around the route shape, the working space, and avoidance of areas near the body and plant equipment complicated the layout conditions, resulting in greater difficulty of the editing work.

An object of the present invention is to provide a function that enables a piping route shape reflecting the design intention to be quickly generated even when the layout conditions are complicated.

### Solution to Problem

To solve the problem noted above, the invention provides means of weighting, at the time of designing a piping route, nearby spaces of equipment and the working space having such shapes as would become obstacles at the time of designing, and modifying the route shape by altering the weights of the spaces.

### Advantageous Effects of Invention

According to the invention, it is made possible to make a route shape of high design quality in a short period of time by weighting nearby spaces so shaped as to become obstacles and facilitate trials and errors in piping route designing,

### BRIEF DESCRIPTION OF DRAWINGS

FIG. 1 shows an embodiment of a piping or wiring support device pertaining to the invention.

FIG. 2 is a block diagram of a routing difficulty level calculating function.

FIG. 3 is a block diagram of a route shape generating function.

FIG. 4 is a block diagram of an interface function.

FIG. 5 charts the processing flow of a piping or wiring support device.

FIG. 6 shows route search space parameters.

FIG. 7 shows a scalar field.

FIG. 8 shows the weight of space.

FIG. 9 shows a layout condition database.

FIG. 10 shows an obstacle distance field.

FIG. 11 shows a nearby space of individual obstacle shape.

FIG. 12 shows a weight table.

FIG. 13 shows layout condition common parameters.

FIG. 14 shows a layout condition individual parameter database.

FIG. 15 shows an example of weight function.

FIG. 16 is a block diagram of layout condition generating means.

FIG. 17 shows layout condition generation parameters.

FIG. 18 charts the processing flow of a layout condition generation parameters acquiring unit.

FIG. 19 charts the processing flow of an obstacle distance field calculating unit.

FIG. 20 charts the processing flow of a weight table calculating unit.

FIG. 21 is a block diagram of scalar field generating means.

FIG. 22 charts the processing flow of a route search space discretizing unit.

FIG. 23 charts the processing flow of a space weight registration unit.

FIG. 24 is a block diagram of endpoint distance field generating means.

FIG. 25 shows an end point distance field.

FIG. 26 charts the processing flow of the end point distance field generating means.

FIG. 27 is a block diagram of route point sequence generating means.

FIG. 28 shows a route passing point sequence.

FIG. 29 is a schematic diagram of route passing point sequence generation using an end point distance field.

FIG. 30 is a block diagram of common parameter editing means.

FIG. 31 shows a common parameter editing GUI.

FIG. 32 is a block diagram of layout condition parameter editing means.

FIG. 33 shows a layout condition parameter editing GUI.

### DESCRIPTION OF EMBODIMENTS

An embodiment of the invention will be described below with reference to drawings.

### Embodiment

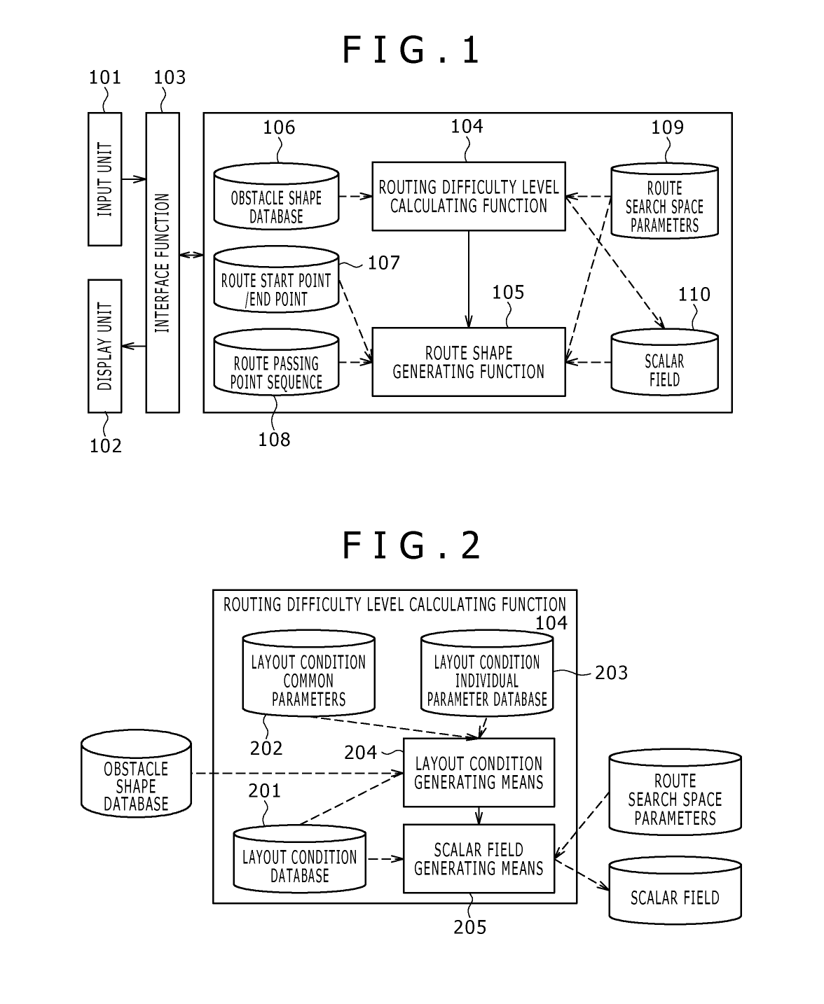

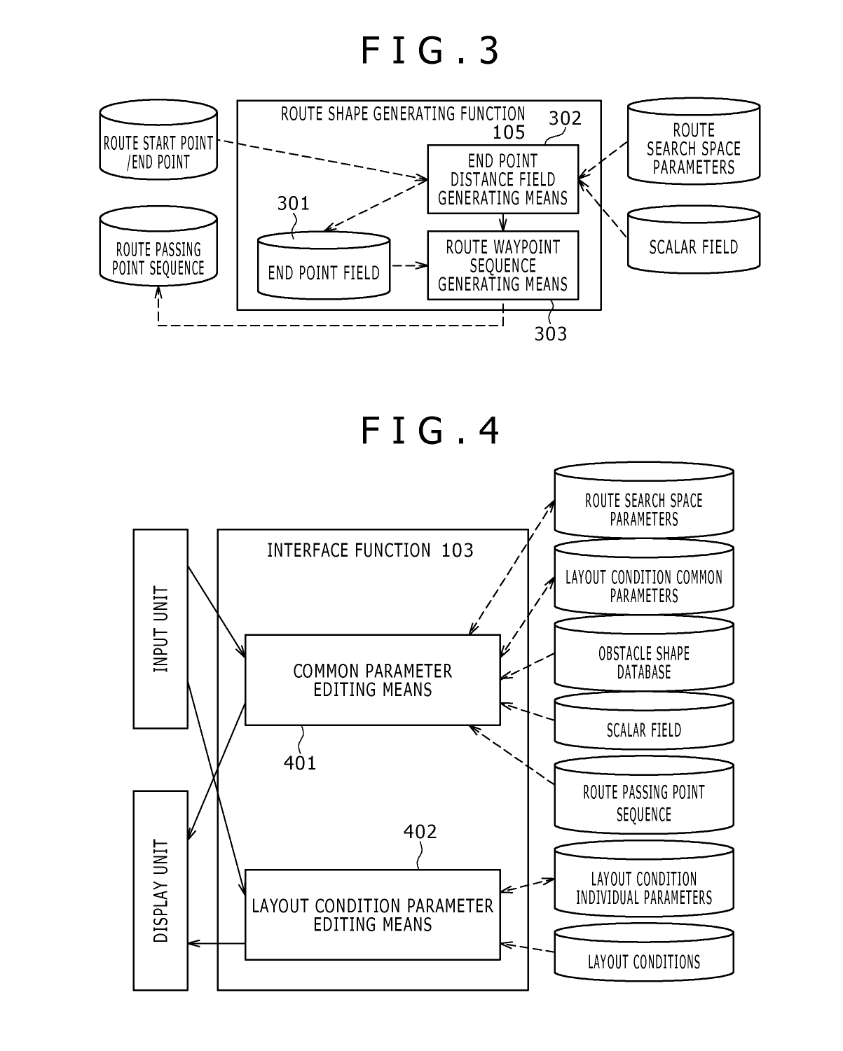

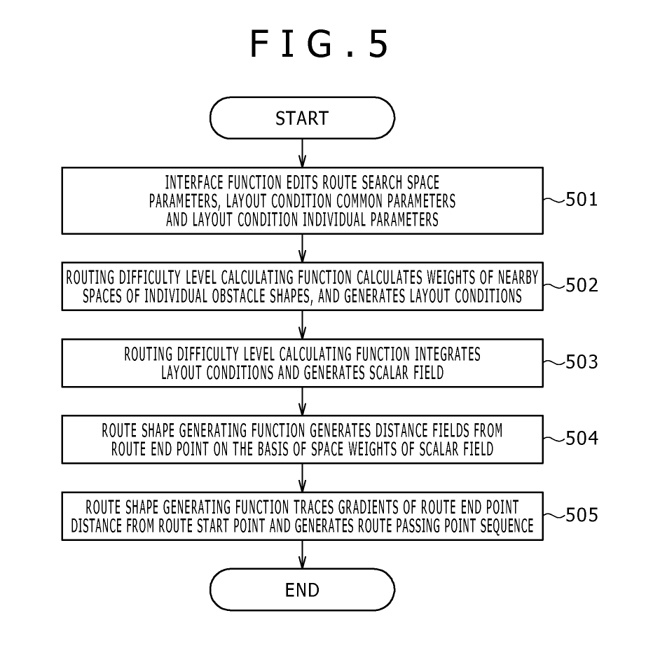

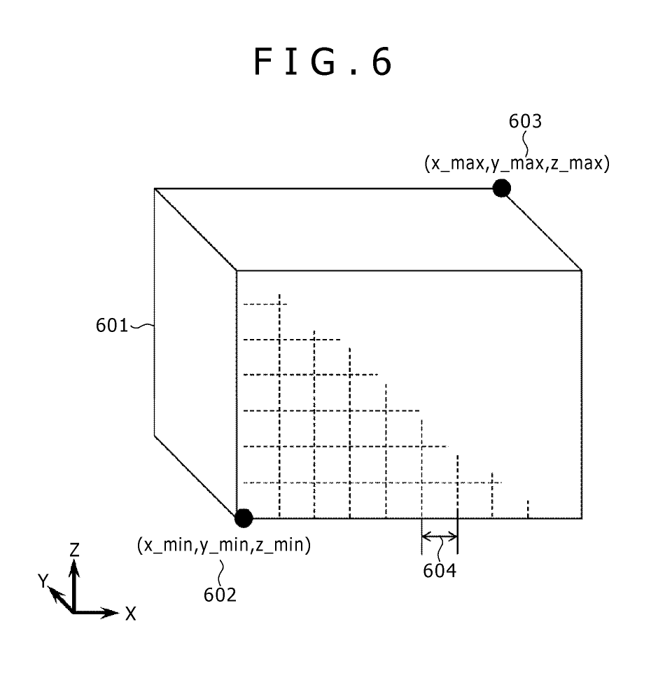

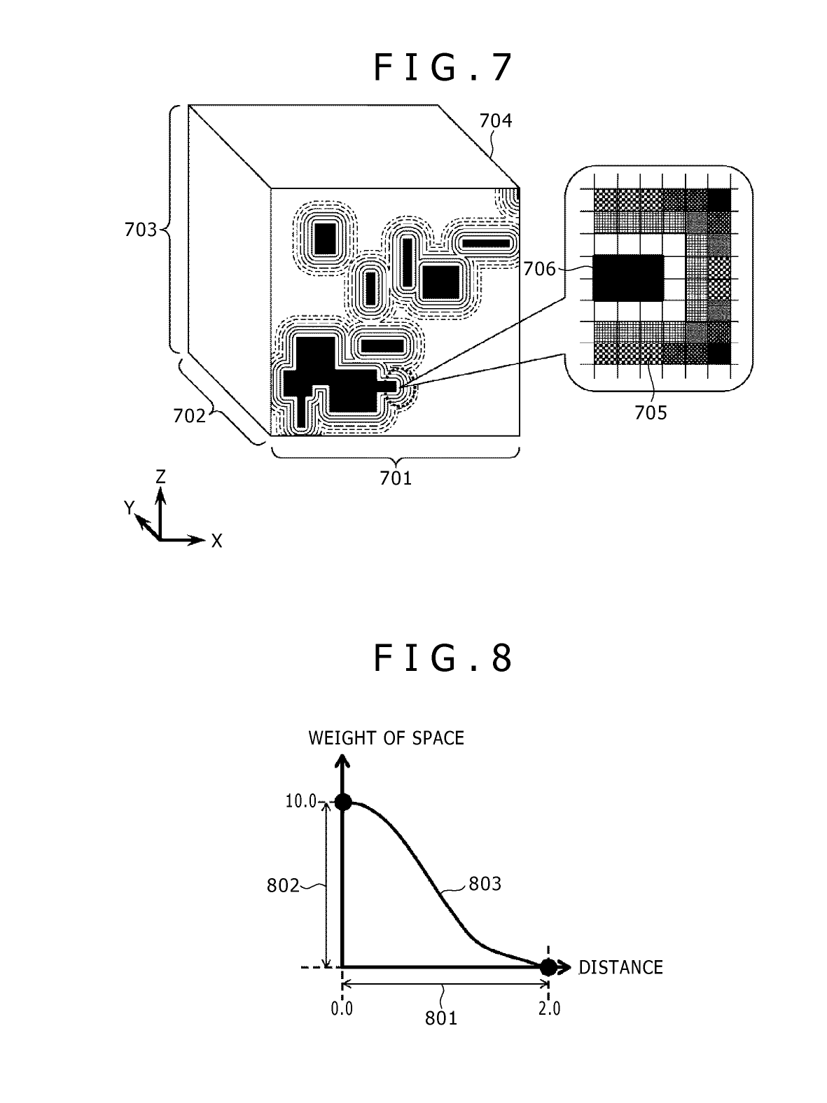

FIG. 1 shows a piping or wiring support device in an embodiment of the invention. The piping or wiring support device is a device for supporting installation designing of piping or wiring, a route designing support device. The route designing support device comprises an input unit 101, a display unit 102, an interface function 103, a routing difficulty level calculating function 104, a route shape generating function 105, the obstacle shape database 106, a route start point/end point 107, a route passing point sequence database 108, a route search space parameter database 109 and a scalar field database 110. The input unit 101 is a device for acquiring inputs by users, such as a mouse or a keyboard. The display unit 102 is a device for visualizing information on the route shape and the space around the route, such as a display. A detailed example of the interface function 103 will be described afterwards with reference to FIG. 4. The routing difficulty level calculating function 104 is a function to numerically express how the difficulty level of route arrangement is in the searched space as weights of space and calculate the weights of space in the whole route search space, an example of whose details will be described afterwards with reference to FIG. 2. The route shape generating function 105 is a function to calculate the route shape making links among the route start point/end point data of the route start point/end point 107 by generating a distance space from the route endpoint in the whole route search space and tracing the gradients of the distance space, an example of whose details will be described afterwards with reference to FIG. 3. A detailed example of actions of the route designing support device will be described afterwards with reference to FIG. 5. The obstacle shape database 106 keeps on record shape data IDs, which are names by which individual shapes of obstacles can be uniquely identified and three-dimensional shapes that make possible distinction between the external space and the inner space of a shape. For instance, it includes common CAD data. The route start point/end point 107 keeps on record coordinate data of the route start point and the route end point. The route passing point sequence database 108 keeps on record apex coordinates of an array data that holds polygonal line linking the start and endpoints of the route, an example of whose details will be described afterwards with reference to FIG. 28. The route search space parameter database 109 keeps on record data that holds positional of the route start point and the route end point in the XYZ space of the rectangular parallelepiped three-dimensional orthogonal coordinate system, an example of whose details will be described afterwards with reference to FIG. 6. The scalar field database 110 keeps on record the weight of space information, which concerns the routing difficulty level in the route search space, as the scalar field, an example of whose details will be described afterwards with reference to FIG. 7. In the interface function 103, the routing difficulty level calculating function 104 and the route shape generating function 105, the processor a computer interprets and executes programs, each to realize its function. The obstacle shape database 106, the route start point/end point database 107, the route passing point sequence database 108, the route search space parameter database 109 and the scalar field database 110 are recording devices, and can be provided either inside and outside the computer, or each of a plurality of databases can be provided independently or integrated with others.

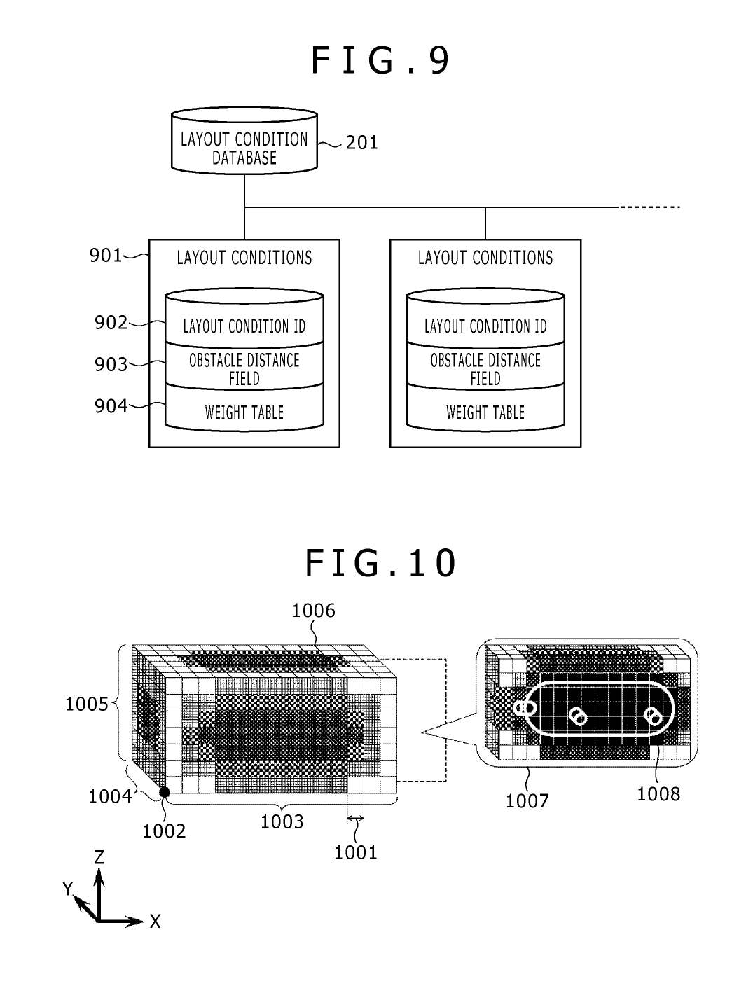

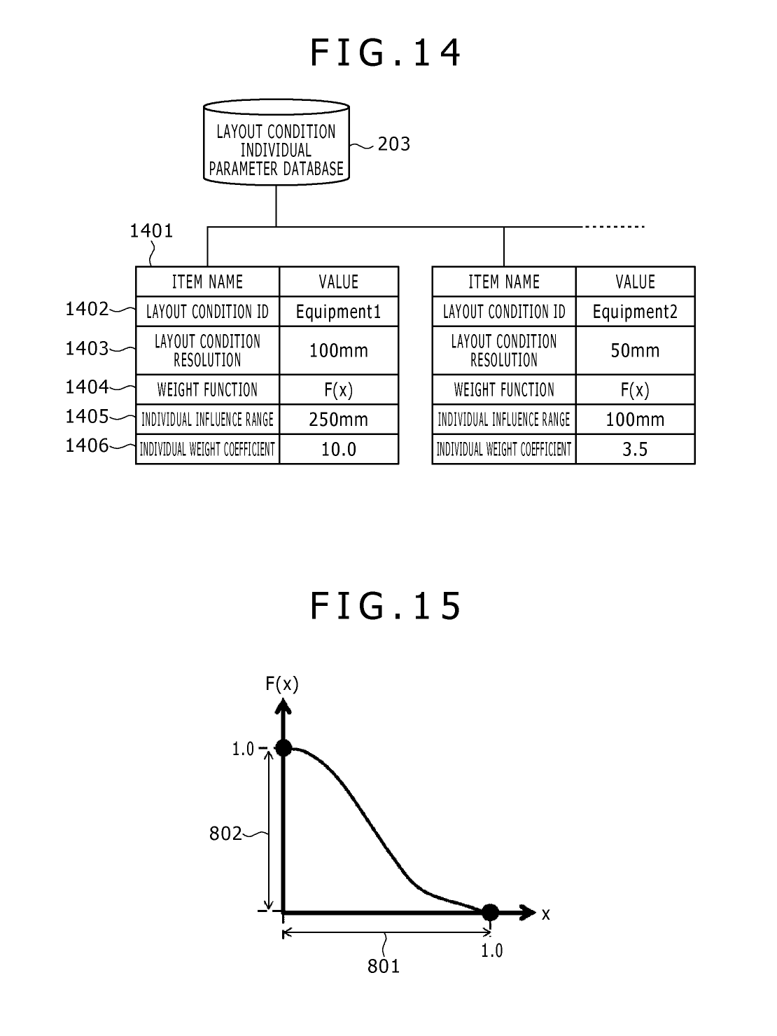

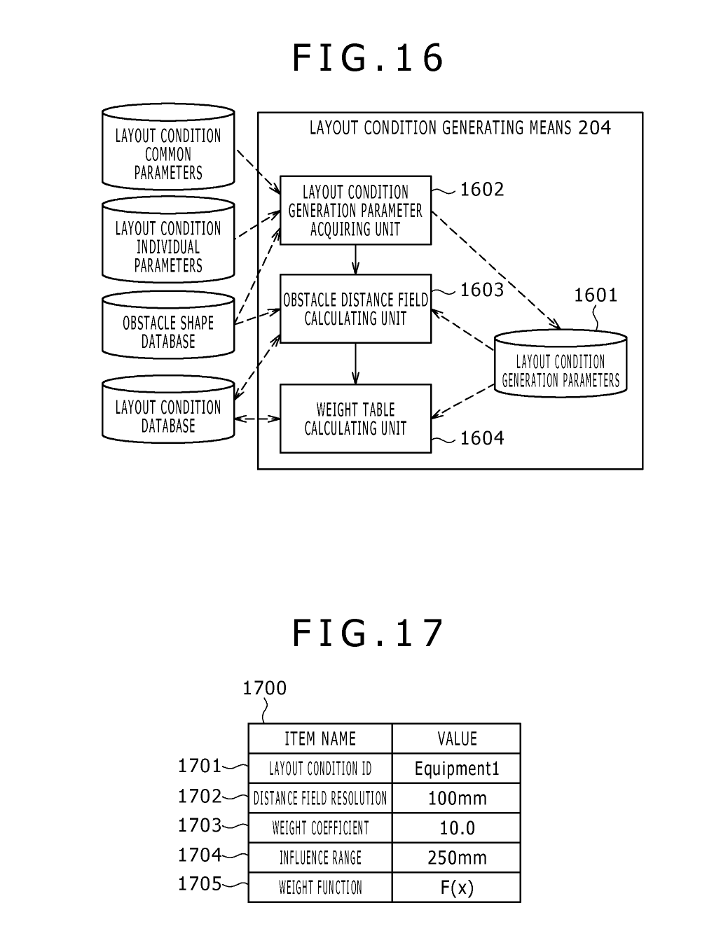

FIG. 2 shows an example of the routing difficulty level calculating function 104 in the embodiment of the invention. The routing difficulty level calculating function 104 is a function to express the relative difficulty level of route arrangement in the route search space as a weight of space in numerical values and to calculate the weight of space in the whole route search space, and comprises a layout condition database 201, layout condition common parameter database 202, a layout condition individual parameter database 203, layout condition generating means 204 and scalar field generating means 205. A detailed example of the layout condition database 201 details will be described afterwards with reference to FIG. 9. A detailed example of the layout condition common parameter database 202 details will be described afterwards with reference to FIG. 13. A detailed example of the layout condition individual parameter database 203 will be described afterwards with reference to FIG. 14. A detailed example of the layout condition generating means 204 details will be described afterwards with reference to FIG. 16. A detailed example of the scalar field generating means 205 details will be described afterwards with reference to FIG. 21.

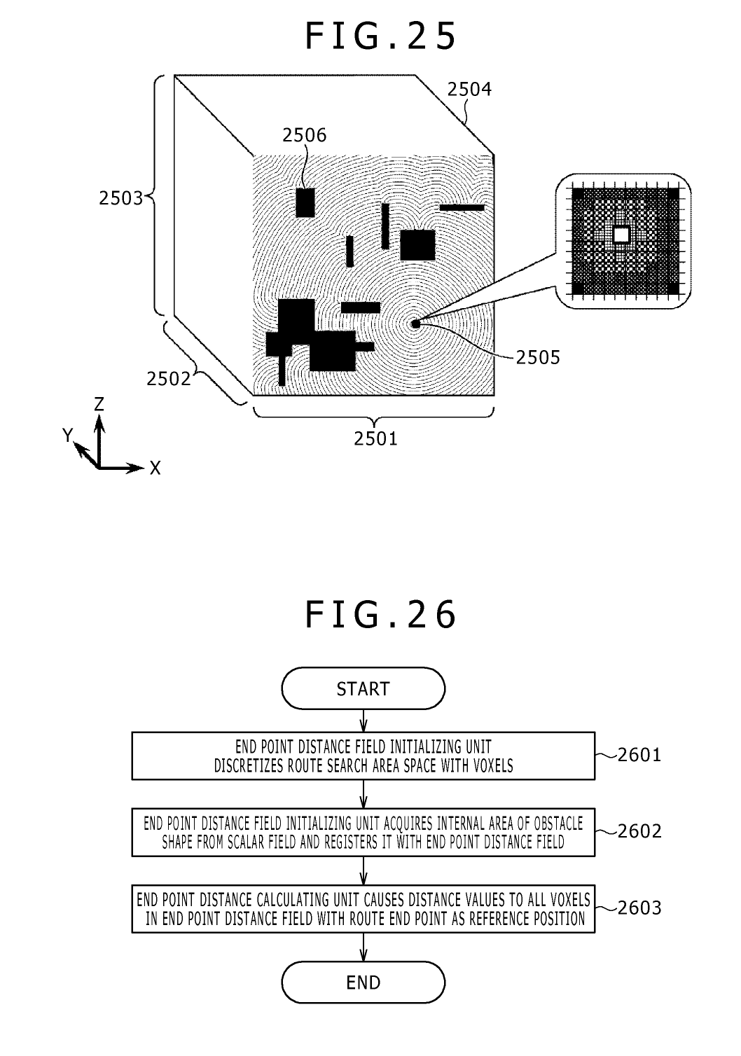

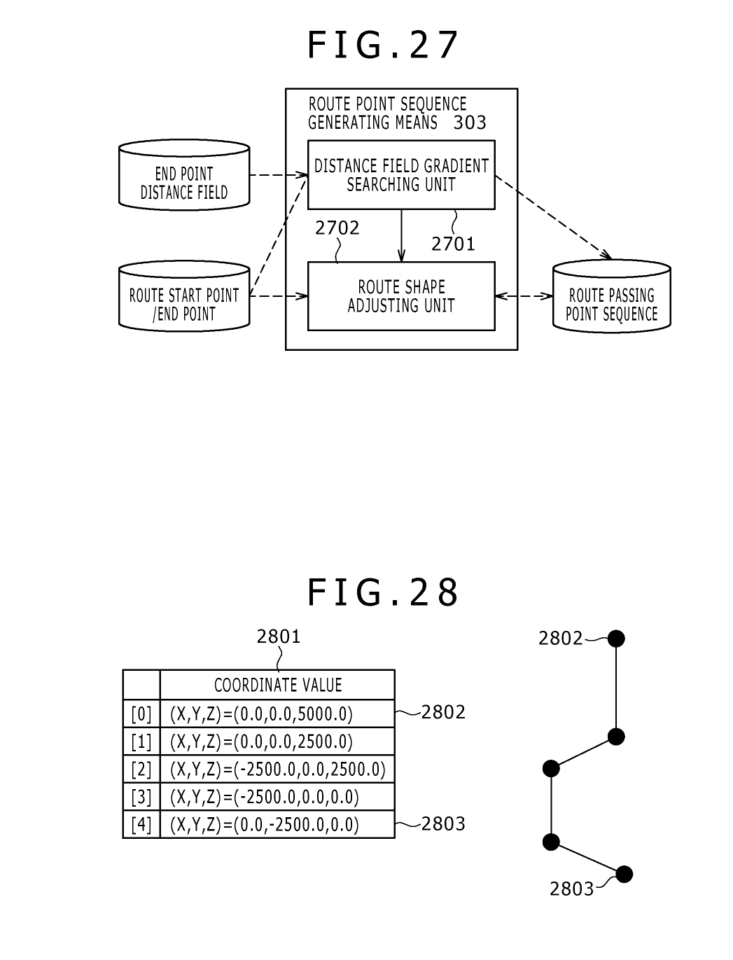

FIG. 3 shows an example of the route shape generating function 105. The route shape generating function 105 is a function to generate distance fields from route end points in the whole route search space and to figure out a route shape linking the route start point/end point data of the route start point/end point 107 by tracing the gradients of distance fields, and comprises end point distance field generating means 302 to generate endpoint distance field data, which is information on distances from route end points recorded in an end point distance field database 301 and end point distance field data of the end point distance field database 301; and route point sequence generating means 303 to generate a route shape by tracing the gradients of data of the end point distance field database 301. A detailed example of the end point distance field database 301 will be described afterwards with reference to FIG. 25. A detailed example of the end point distance field generating means 302 will be described afterwards with reference to FIG. 24. The route point sequence generating means 303 generates a route linking a route start point and a route end point by tracing the gradients from the route start point to the endpoint distance field. A more specific detailed example will be described afterwards with reference to FIG. 27.

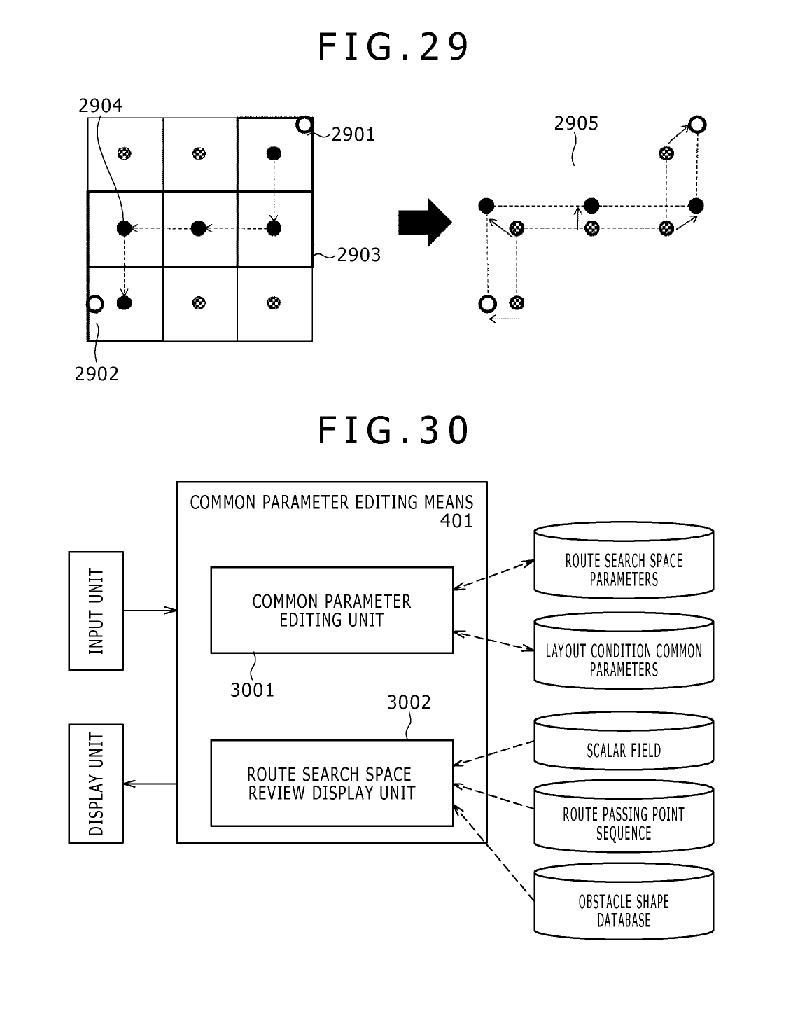

FIG. 4 shows an example of the interface function 103 in the embodiment of the invention. The interface function 103 comprises common parameter editing means 401 and layout condition parameter editing means 402. A detailed example of the common parameter editing means 401 will be described afterwards with reference to FIG. 30. A detailed example of the layout condition parameter editing means 402 will be described afterwards with reference to FIG. 32.

FIG. 5 charts the processing flow of the piping or wiring support device in the embodiment of the invention. At a processing step 501, the interface function 103 performs editing (including input acceptance and data alteration) of data in the route search space parameter database 109, data in the layout condition common parameter database 202 and values of layout condition individual parameters held by the layout condition individual parameter database 203 by utilizing user inputs from the input unit.

At a processing step 502, the routing difficulty level calculating function 104 generates layout conditions for each individual obstacle shape on the basis of the layout condition common parameters and the layout condition individual parameters.

At a processing step 503, the routing level calculating function 104 integrates layout conditions to generate a scalar field. Thus, it calculates the weights of space in the whole route search space by acquiring weights of space from all the layout conditions held by the layout condition database 201 and registering them with the scalar field.

At a processing step 504, the route shape generating function 105 calculates propagation of distance information with the route end point as reference position, and generates end point distance fields on the basis of space weights of the scalar field. On that occasion, it weights distance propagation on the basis of weight of space information of the scalar field.

At a processing step 505, the route shape generating function 105 traces the gradients of the route end point distance fields from the route start points to generate a route passing point sequence.

FIG. 6 shows an example of data configuration of the route search space parameter database 109 in the embodiment of the invention. The route search space parameter database 109 stores data that holds information on a rectangular parallelepiped area 601 containing route start points/end points in the XYZ space of a rectangular parallelepiped three-dimensional orthogonal coordinate system, and comprises a searched space minimum point 602, a searched space maximum point 603 and a searched space resolution 604. The searched space minimum point 602 represents coordinate values of an apex where all the XYZ components, among apexes constituting the rectangular parallelepiped area, are the smallest. The searched space maximum point 603 represents coordinate values of an apex where all the XYZ components, among apexes constituting the rectangular parallelepiped area, are the greatest. The searched space resolution 604 is the size of a cube known as a voxel when the route search space is discretized with this cube. The route search space parameter database 109 keeps on record data of these items of positional information.

FIG. 7 shows an example of data configuration in the scalar field database 110 in the embodiment of the invention. The scalar field database 110 has a volume data structure resulting from discretization of the route search space with voxels, and comprises an X-direction voxel division number 701, a Y-direction voxel division number 702 and a Z-direction voxel division number 703 in the orthogonal coordinate space of the X axis, the Y axis and the Z axis and a three-dimensional voxel array 704 whose dimensions are the X-direction voxel division number 701, the Y-direction voxel division number 702 and the Z-direction voxel division number 703. Each of the voxels constituting the scalar field holds the weight of space as a real number value of not less than zero. For instance, a voxel 705 in a space holds the value of a weight of space incurred by the shape of a nearby obstacle. However, a voxel 706 within the shape of an obstacle, as it has no weight of space, holds “−1” as an invalid weight value in this embodiment.

FIG. 8 outlines weighting in the embodiment of the invention. The weight of space is the difficulty level of route arrangement arising within a certain distance from an obstacle shape. The weight of space takes on a real number value of not less than zero, and this value rises with an increase in the difficulty of route arrangement. In this embodiment, the weight of space is calculated by using an influence range 801, which is the distance range of weight calculation, and a weight function shape 803 whose value can be controlled dependent on a weight coefficient 802, which is the intensity of the weight. Although a case of using a function to perform weighting was described here, some other method using no function also is conceivable. For instance, by using preset data in weighting a nearby space of a potentially obstacle-posing shape, the data can serve as data from the scalar field database 110 of FIG. 7.

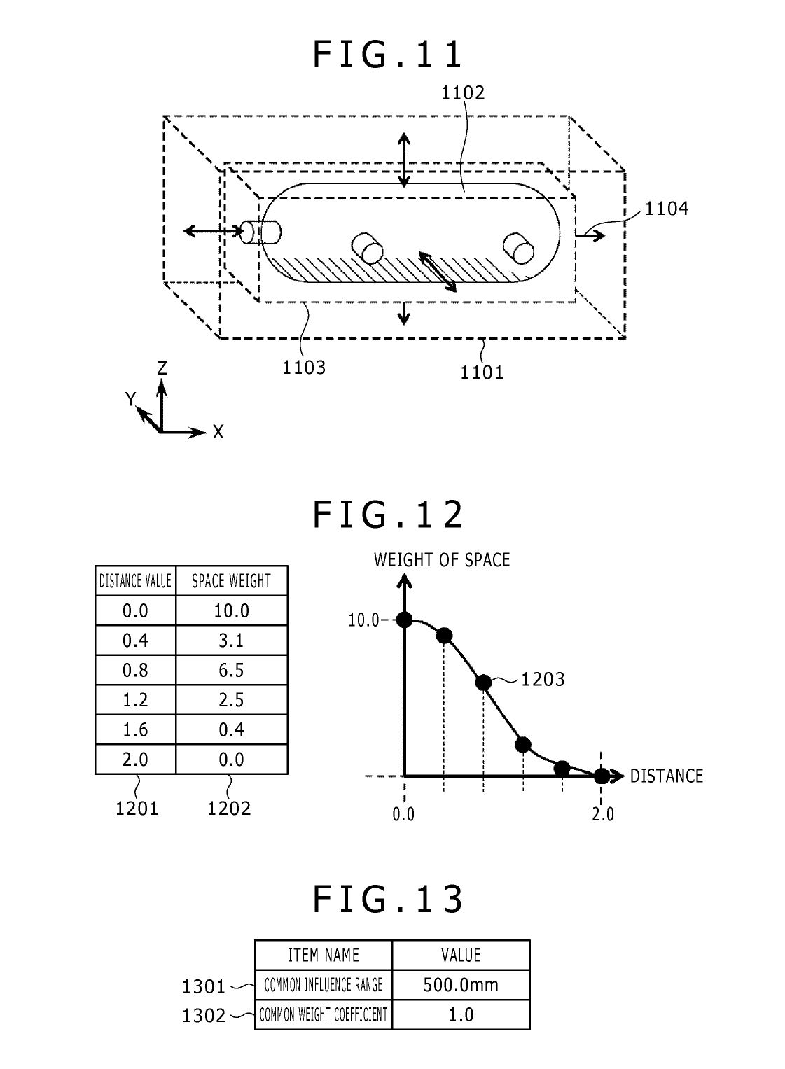

FIG. 9 shows an example of the layout condition database 201 in the embodiment of the invention. The layout condition database 201 is a database holding a plurality of layout conditions 901. The layout conditions 901, constituting information on the nearby weight of space of each obstacle shape, comprises a layout condition ID 902, an obstacle distance field 903 and a weight table 904. The layout condition ID 902 is an ID that can not only uniquely identify the layout conditions 901 but also can be utilized for establishing association with an obstacle shape, and in this embodiment a shape data ID held by the obstacle shape is used. Detailed examples of the obstacle distance field 903 will be described afterwards with reference to FIG. 10 and FIG. 11. A detailed example of the weight table 904 will be described afterwards with reference to FIG. 12.

FIG. 10 shows an example of the obstacle distance field 903 in the embodiment of the invention. The obstacle distance field 903 has a volume data structure of discretizing the nearby spaces of individual obstacle shapes with voxels and storing information on distance from an obstacle shape in each voxel, and comprises a distance voxel size 1001, which is the length of one side of a voxel; an obstacle distance field origin 1002 in an XYZ orthogonal coordinate space; an X-direction voxel division number 1003; a Y-direction voxel division number 1004; a Z-direction voxel division number 1005; and a distance voxel three-dimensional array 1006 whose dimensions are the X-direction voxel division number 1003, the Y-direction voxel division number 1004 and the Z-direction voxel division number 1005. Each voxel of the three-dimensional voxel array 1006 holds the shortest distance from the obstacle shape surface. However, as shown in a section 1007 of the distance field, a voxel 1008 the obstacle shape holds “−1”, which is invalid information in this embodiment.

Further in FIG. 11, an embodiment of a nearby space of an individual obstacle shape is shown. A nearby space 1101 of the obstacle shape is a rectangular parallelepiped area resulting from expansion of a bounding box 1103, which is the smallest cuboid containing a cubic shape 1102 of the obstacle, by an influence range 1104 of the weight of space.

FIG. 12 shows an example of the weight table 904 in the embodiment of the invention. The weight table 904 is a list of numerical values holding the weights of space in the nearby spaces of individual obstacle shapes, and consists of combinations of distance values 1201 and space weights 1202 each matching a distance value. The distance values 1201 are values of discrete points 1203 on distance sections, of which the minimum value is zero and the maximum value is the influence range 1104. The space weights 1202 are values of the weight function shapes 803 calculate by using the distance values of the discrete points 1203.

FIG. 13 shows examples of data in the layout condition common parameter database 202 in the embodiment of the invention. The layout condition common parameters are parameters permitting collective control of the weights of space in all the layout conditions 901, and hold a common influence range 1301 and a common weight coefficient 1302. The common influence range 1301 is a real numerical value of not less than zero to adjust the influence range 801. The common weight coefficient 1302 is a real numerical value of not less than zero to adjust the weight function 802.

FIG. 14 shows the layout condition individual parameter database 203 in the embodiment of the invention. The layout condition individual parameter database 203 is a database holding a plurality of layout condition individual parameters 1401. The layout condition individual parameters 1401 are data holding set values required for generating the layout conditions 901, and comprises a layout condition ID 1402, a layout condition resolution 1403, a weight function 1404, an individual influence range 1405 and an individual weight coefficient 1406. The layout condition ID 1402 is an ID that can not only uniquely identify the layout condition individual parameters 140 but also can be utilized for establishing association with an obstacle shape, and in this embodiment shape data IDs held by obstacle shapes are used. The layout condition resolution 1403 is the size of the voxel of the obstacle distance field 903.

FIG. 15 shows the weight function 1404 in the embodiment of the invention. The weight function 1404, using a distance x as a variable, outputs values from 0 to 1 in a range of 0 to 1. By multiplying the weight function 1404 by the influence range 801 in the distance and multiplying F (x) by the weight coefficient 802, it calculates the weight of space.

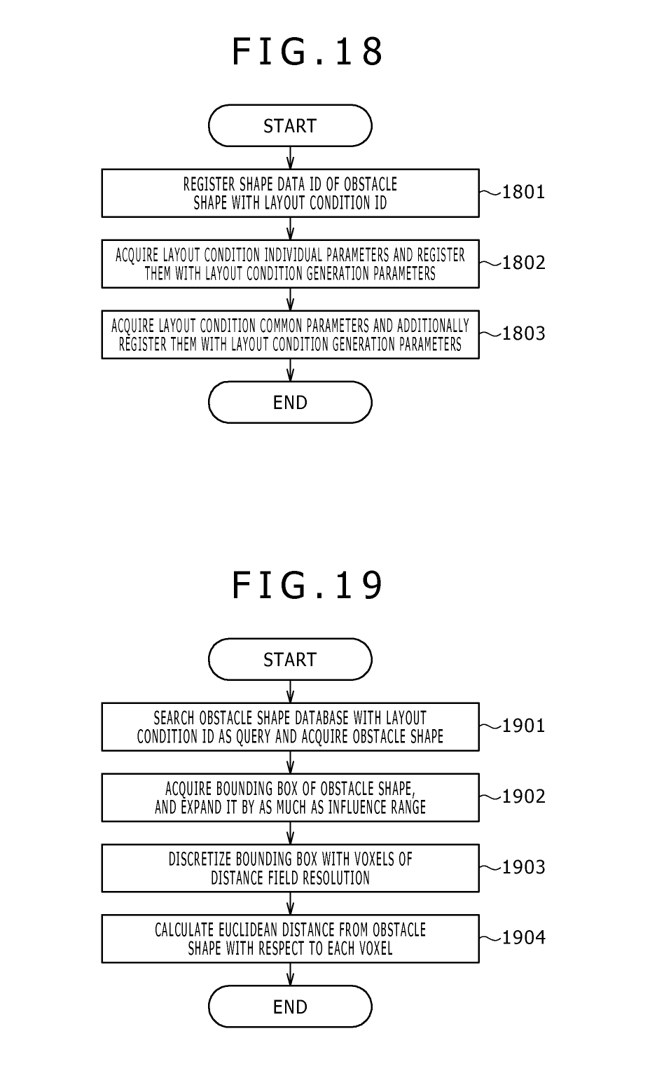

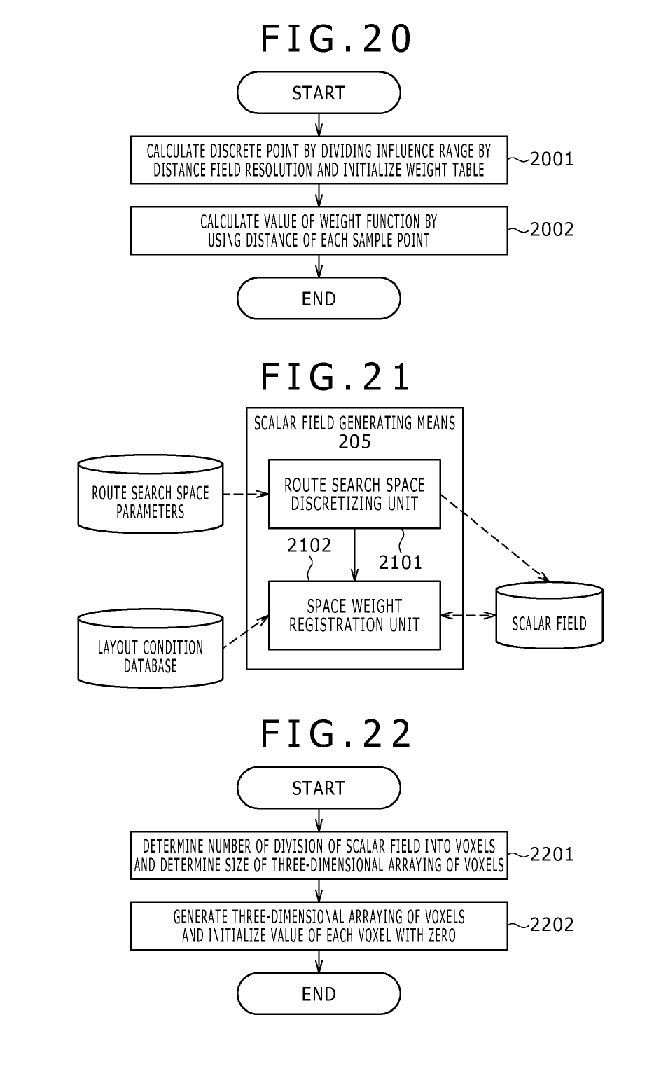

FIG. 16 shows an example of the layout condition generating means 204 in the embodiment of the invention. The layout condition generating means 204 is means of generating the layout conditions 901 for individual obstacle shapes and storing them into the layout condition database 201, and comprises data of a layout condition generation parameter database 1601 for use in the generation of layout conditions, a layout condition generation parameters acquiring unit 1602 that generates data of the layout condition generation parameter database 1601 from data of the layout condition common parameter database 202 and data of the layout condition individual parameter database 203 as inputs, an obstacle distance field calculating unit 1603 that calculates the obstacle distance field 903 and a weight table calculating unit 1604 that calculates the weight table 904. A detailed example of the layout condition generation parameter database 1601 will be described afterwards with reference to FIG. 17. A detailed example of the layout condition generation parameters acquiring unit 1602 will be described afterwards with reference to FIG. 18. A detailed example of the obstacle distance field calculating unit 1603 will be described afterwards with reference to FIG. 19. A detailed example of the weight table calculating unit 1604 will be described afterwards with reference to FIG. 20.

FIG. 17 shows an example of the layout condition generation parameter database 1601 in the embodiment of the invention. Layout condition generation parameters 1700 put together data held by the layout condition common parameter database 202 and data of the layout condition individual parameters 1401 held by the layout condition individual parameter database 203, and comprises a layout condition ID 1701, a distance field resolution 1702, a weight coefficient 1703, an influence range 1704 and a weight function 1705.

FIG. 18 charts the processing flow of the layout condition generation parameters acquiring unit 1602 in the embodiment of the invention. At a processing step 1801, one obstacle shape is acquired from the obstacle shape database, and a shape data ID is registered with the layout condition ID 1701 of the layout condition generation parameter database 1601. At a processing step 1802, the layout condition individual parameters 1401 is acquired from the layout condition individual parameter database 203 with the layout condition ID 1701 as the query, and registered with the layout condition generation parameter database 1601. More specifically, the layout condition resolution 1403 is registered with the distance field resolution 1702, the individual weight coefficient 1406 with the weight coefficient 1703, the individual influence range 1405 with the influence range 1704, and the weight function 1404 with the weight function 1705. At a processing step 1803, the common influence range 1301 acquired from the layout condition common parameter database 202 is added to the influence range 1704, and the weight coefficient 1703 is multiplied by the common weight coefficient 1302.

FIG. 19 charts the processing flow of the obstacle distance field calculating unit 1603 in the embodiment of the invention. At a processing step 1901, the obstacle shape is acquired by searching the obstacle shape database with the layout condition ID as the query. At a processing step 1902, the bounding box 1103, which is the smallest rectangular parallelepiped area containing any obstacle shape is acquired, and the apexes of the bounding box are expanded outward as much as the influence range 1104 to generate the nearby space 1101 of the obstacle shape. At a processing step 1903, the nearby space 1101 of the obstacle shape is discretized with a voxel of the size of the distance field resolution 1702 to generate the obstacle distance field 903. At a processing step 1904, the Euclidean distance from the obstacle shape is calculated for every voxel held by the three-dimensional voxel array 1006 of the obstacle distance field 903. To add, a voxel 1007 within the obstacle shape is supposed to be an invalid distance value “−1”.

FIG. 20 charts the processing flow of the weight table calculating unit 1604 in the embodiment of the invention. At a processing step 2001, the section of the influence range 1704 is divided by the distance field resolution 1702 to figure out discrete points 1203 on a finite number of distance spaces. The distance values of the discrete points are added to the distance values 1201 of the space weight table 904. Ata processing step 2002, weights of space corresponding to the distance values 1201 are calculated. In this embodiment, normal distance values resulting from normalization of distance values in the influence range are utilized to calculate the weight function 1705, and values obtained by multiplying the calculated results by the weight coefficient 1705 are registered with the space weight 1202.

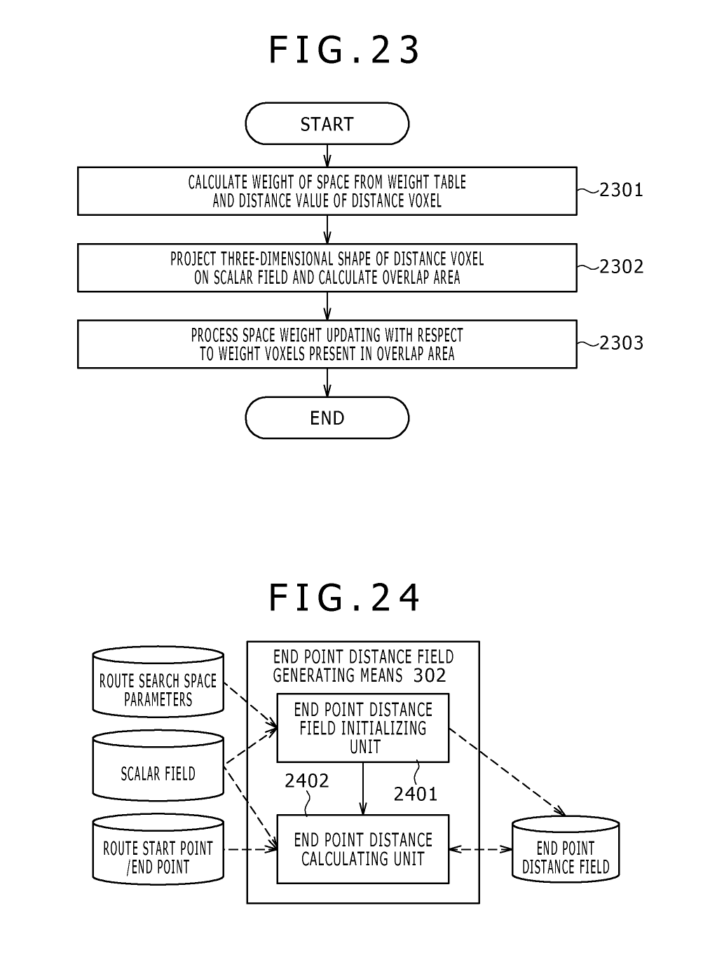

FIG. 21 shows the scalar field generating means 205 in the embodiment of the invention. The scalar field generating means 205 is means of calculating the weight of space in the route search space, and comprises a route search space discretizing unit 2101 that discretizes the route search space into voxels to initialize the scalar field and a space weight registration unit 2102 that registers the weights of space with the scalar field by using the layout condition database 201. A detailed example of the route search space discretizing unit 2101 will be described afterwards with reference to FIG. 22. A detailed example of the space weight registration unit 2102 will be described afterwards with reference to FIG. 23.

FIG. 22 charts the processing flow of the route search space discretizing unit 2101 in the embodiment of the invention. At a processing step 2201, the searched space minimum point 602 is subtracted from the searched space maximum point 603 of the route search space parameter database 109 to calculate the lengths of sides in the X, Y and Z axial directions of the rectangular parallelepiped area 601. Further, the lengths of the three sides of the rectangular parallelepiped area 601 are divided by the searched space resolution 604 to calculate the X-direction voxel division number 701, the Y-direction voxel division number 702 and the Z-direction voxel division number 703. At a processing step 2202, the three-dimensional voxel array 704 whose dimensions are the X-direction voxel division number 701, the Y-direction voxel division number 702 and the Z-direction voxel division number 703 are generated, and the weight value of each voxel is initialized with zero.

FIG. 23 charts the processing flow of the space weight registration unit 2102 in the embodiment of the invention. The space weight registration unit 2102 registers the weights of space with the scalar field by performing the following steps of processing for each of the layout conditions 901 acquired from the layout condition database 201. At a processing step 2301, one distance voxel is acquired from the obstacle distance field 903, and the weight of space is calculated by using the weight table 904 and the distance value of the distance voxel. At a processing step 2302, the cubic shape of the distance voxel acquired at a step 1 is projected on the scalar field to detect the overlap area of the distance voxel with the cubic shape. At a processing step 2303, every voxel in the scalar field present in the overlap area is processed for updating of the weight of space. If the weight of space acquired at the step 1 is greater than the value of the scalar field voxel, the weight of space of the scalar field voxel is updated. However, if the weight of space of the distance voxel is “−1”, “−1” is registered with the voxel in the scalar field.

FIG. 24 shows an example of the end point distance field generating means 302 in the embodiment of the invention. The end point distance field generating means 302 comprises an end point distance field initializing unit 2401 and an end point distance calculating unit 2402. A detailed example will be described afterwards with reference to FIG. 25 and FIG. 26.

FIG. 25 shows an example of data configuration of the end point distance field database 301 in the embodiment of the invention. An end point distance field is volume data that holds distance information from a route end point 2505 in the whole area of the route search space, and comprises an X-direction voxel division number 2501 in an orthogonal coordinate space formed of the X axis, the Y axis and the Z axis, a Y-direction voxel division number 2502, a Z-direction voxel division number 2503, and a three-dimensional voxel array 2504 whose dimensions are the X-direction voxel division number 2501, the Y-direction voxel division number 2502 and the Z-direction voxel division number 2503.

FIG. 26 charts the processing flow of the end point distance field generating means 302 in the embodiment of the invention. At a processing step 2601, the end point distance field initializing unit 2401 generates an end point distance field by discretizing the route search space with voxels. Each voxel held by the end point distance field is initialized with a distance value zero. At a processing step 2602, the end point distance field initializing unit 2401 detects from the scalar field a pertinent voxel group of −1 in weight value within the obstacle shape, and registers the invalid distance value “−1” with the pertinent voxel in the end point distance field. At a processing step 2603, the end point distance calculating unit 2402 causes distance information to be propagated to every voxel whose distance value is zero in the end point distance field with the route endpoint as the reference position. In this embodiment, while accumulating distance values from voxels constituting the route end point, propagation is accomplished by tracing from one voxel to the adjoining voxel. In the distance propagation, by raising the accumulation degree of distance values in proportion to the weight of space in the scalar field, the distance value from the route end point is shortened with an increase in the distance of the voxel from the obstacle shape.

FIG. 27 shows the route point sequence generating means 303 in the embodiment of the invention. The route point sequence generating means 303 is means of generating route passing point sequence data of the route passing point sequence database 108 linking the route start point and end point by using data of the end point distance field database 301, and comprises a distance field gradient searching unit 2701 and a route shape adjusting unit 2702. A detailed example of the distance field gradient searching unit 2701 will be described afterwards with reference to FIG. 28. A detailed example of the route shape adjusting unit 2702 will be described afterwards with reference to FIG. 29.

FIG. 28 shows an example of data configuration of the route passing point sequence database 108 in the embodiment of the invention. The route passing point sequence data is array data 2801 holding the apex coordinates of a polygonal line linking the route start point and end point, where in a route start point position 2802 is the leading element, and a route end point position 2803 the trailing element, of the array.

In the distance field gradient searching unit 2701, the route shape is figured out by tracing gradients from a vowel corresponding to the route start point until a voxel corresponding to the route end point in the end point distance field database 301. As shown in FIG. 28, center point coordinates 2904 of a passed voxel group 2903 that arrives from a voxel corresponding to a route start point 2901 at a voxel corresponding to a route endpoint 2902 are acquired, and a route passing point sequence is tentatively determined.

In the route shape adjusting unit 2702, the start point/end point positions of the route passing point sequence tentatively determined by the distance field gradient searching unit 2701 are caused to coincide with the route start point and end point. As indicated by 2905 in FIG. 29, to match the two apexes, leading and trailing, of the route passing point sequence respectively with the route start point 2901 and the route endpoint 2902, the whole route passing point sequence is deformed expansively or contractively.

FIG. 30 shows the common parameter editing means 401 in the embodiment of the invention. The common parameter editing means 401 comprises a common parameter editing unit 3001 and a route search space preview display unit 3002.

The common parameter editing unit 3001 is a function the respective set values of the data of the route search space parameter database 109 and the data of the layout condition common parameter database 202 by outputting a graphical user interface (GUI) to the display unit 102 and acquiring user operations from the input unit 101.

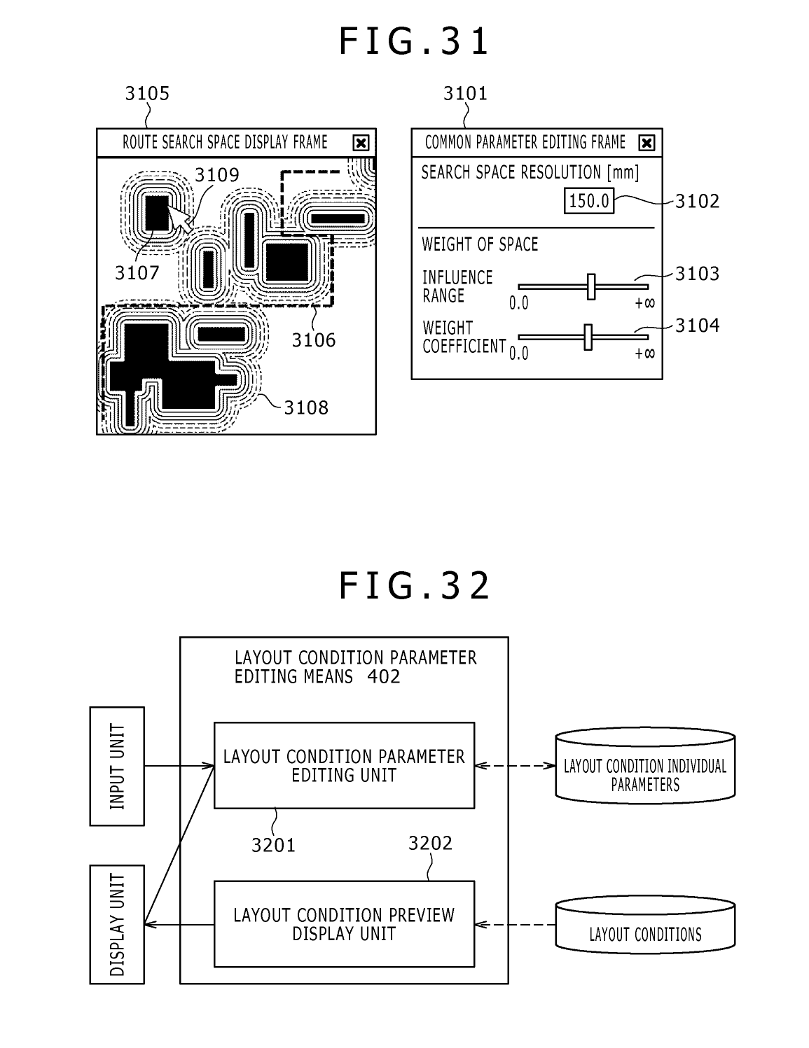

A common parameter editing frame 3101 of FIG. 31 is an embodiment of the common parameter editing unit 3001, and is provided with a route search space resolution input field 3102 that sets the value of the route search space resolution 604 by inputting numeric values to a text field, a common influence range adjusting slider 3103 that inputs the value of the common influence range 1301 through slider operation and a the common weight coefficient adjusting slider 3104 that inputs the value of the common weight coefficient 1302 through slider operation.

The route search space preview display unit 3002 is means of graphically displaying the weight of space, the obstacle shape and the route shape in the route search space in synchronism with alteration of data in the route search space parameter database 109 and data in the layout condition common parameter database 202 by the common parameter editing unit 3001. It further has a function to choose individual obstacle shapes from the graphic display.

A route search space display frame 3105 of FIG. 31, which is a GUI embodiment of the route search space preview display unit 3002, displays in an overlapped manner a route shape 3106, which is a polygonal line figure linking the route start point/end point 107 representing the coordinates of the start point and end point of the route, and the route passing point sequence database 108 keeping on record a polygonal line figure held as a route passing point; an obstacle shape held by the obstacle shape database 106; and a space weight 3108 held by the scalar field database 110; and performs a picking operation of an obstacle shape 3107 by using a cursor 3109.

The route search space display frame 3105 of FIG. 31 also is a frame for causing the display unit 102 to display the interface function 103. With the piping or wiring support device having the route search space parameter database 109 that holds positional information including the size of the route search space in which piping or wiring is to be accomplished, route search space parameters expressing the discretizing resolution; the scalar field database 110 that holds space weight information representing the routing difficulty level in the route search space; and the obstacle shape database 106 holding shape data that the route shape avoids in the route search space, and an output function (the interface function 103) to display the route search space of the route search space parameter database 109 (displaying of the route search space display frame 3105), to display the obstacle shape of the obstacle shape database 106 (displaying of the obstacle shape 3107 of the route search space display frame 3105) and to display the scalar field, which is space weight information numerically expressing the level of routing difficulty imposed by the obstacle shape of the obstacle shape database 106 on the route search space of the route search space parameter database 109 (displaying of the space weight 3108 of the route search space display frame 3105), it is possible to assist arrangement designing by visually presenting design rules with weights on nearby space of a shape to constitute an obstacle when layout conditions are complicated by congestion of spaces around the route shape the need to avoid areas near the working space, body and plant equipment.

To add, the output function may be the interface function 103 or the like, which is to provide outputs directly to the display unit, or an output function that transmits display information to another output means having a function to cause the output to be provided to a display unit for displaying. The same applies to the following description.

Also, it is possible to assist the operator's arrangement designing by causing a piping or wiring support device having the route start point/end point database 107 representing the coordinates of the start point and end point of the route and the route passing point sequence database 108 holding the coordinates of the passing points of the route linking the start point and end point of the route, and further having an output function to display, in a manner overlapping the displayed scalar field, the route shape 3106, which is a polygonal line figure route linking the start point, the route passing points and the end point thereby to compare on the route search space display frame 3105 the design rules weighting any nearby space of a shape posing an obstacle.

Further, as shown in FIG. 31, where the common parameter editing frame 3101 and the route search space display frame 3105 are displayed in contrast to each other, the common influence range adjusting slider 3103 to alter the influence range of weights of space is displayed, and the common influence range adjusting slider 3103 is adjusted, by providing an output function to display in an interlocked manner alterations of the distance from the obstacle shape 3107 to the outer edge (the farthest part from the obstacle shape 3107) of the nearby space weight 3108, it is made possible to facilitate visual checkup of the set state of the space weight near the obstacle shape.

Or where the common parameter editing frame 3101 and the route search space display frame 3105 are displayed in contrast to each other, the common weight coefficient adjusting slider 3104 to alter the space weight is displayed, and the common weight coefficient adjusting slider 3104 is adjusted, by providing an output function to display in an interlocked manner alterations of the display state of the space weight (which may be alterations in color, gradation or the like) between the outer edge (the farthest part from an obstacle shape 3306) of the space weight 3108 near the obstacle shape and the obstacle shape 3306, it is made possible to facilitate visual checkup of the set state of the space weight near the obstacle shape. In the case illustrated in FIG. 31, the obstacle shape is shown in black, display setting with a high weight coefficient is shown in a solid contour line, and display setting with a low weight coefficient is shown in a broken line or a one-dot chain contour line to vary the weight contour lines.

FIG. 32 shows the layout condition parameter editing means 402 in the embodiment of the invention. The layout condition parameter editing means 402 comprises a layout condition parameter editing unit 3201 and a layout condition preview display unit 3202.

The layout condition parameter editing unit 3201 is means of adjusting various set values of the layout condition individual parameters. In this embodiment, editing of various set values is performed for the layout condition individual parameters of the obstacle shape chosen on the route search space display frame 3105, for instance.

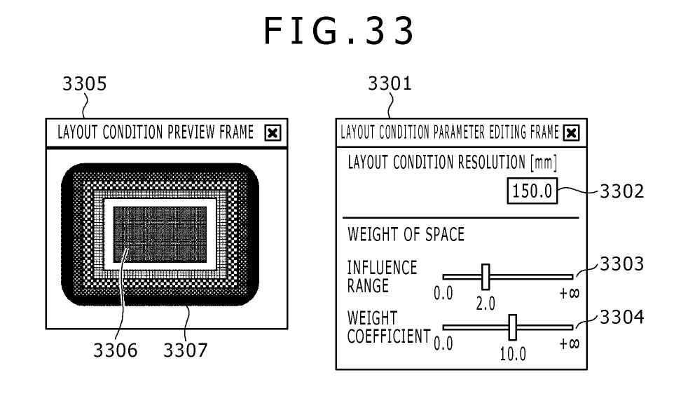

A GUI embodiment of the layout condition parameter editing unit 3201 is shown on a layout condition parameter editing frame 3301 of FIG. 33. The layout condition parameter editing frame 3301 is provided with a layout condition resolution input field 3302 for setting the value of the layout condition resolution 1403 by inputting numerical values to a text field, an individual influence range adjusting slider 3303 for inputting the value of the individual influence range 1405 through slider operation and an individual weight coefficient adjusting slider 3304 for inputting the value of the individual weight coefficient 1406 through slider operation.

The layout condition preview display unit 3202 is means of visualizing the space weight near the obstacle shape in synchronism with alteration of the layout condition individual parameters by the layout condition parameter editing unit 3201.

An embodiment of the layout condition preview display unit 3202 is shown in a layout condition preview frame 3305 of FIG. 33. The layout condition preview frame 3305 is formed of duplicate displaying of the obstacle shape 3306 and a nearby space weight 3307 of the obstacle shape.

By providing an output function to display the layout condition parameter editing frame 3301 and the layout condition preview frame 3305 in contrast to each other and display the individual influence range adjusting slider 3303 for altering the influence range of the space weight and, when the individual influence range adjusting slider 3303 is adjusted, display in an interlocked manner alterations of the state in which the distance from the obstacle shape 3306 to the outer edge (the farthest part from the obstacle shape 3306) of the space weight 3307 near the obstacle shape as shown in FIG. 33, it is made possible to facilitate visual checkup of the set state of the space weight near the obstacle shape.

Also, by providing an output function to display the layout condition parameter editing frame 3301 and the layout condition preview frame 3305 in contrast to each other, display the individual weight coefficient adjusting slider 3304 for altering the space weight and, when the individual weight coefficient adjusting slider 3304 is adjusted, to display in an interlocked manner alterations of the display state of the space weight (which may be alterations in color, gradation or the like) between the outer edge (the farthest part from an obstacle shape 3306) of the space weight 3307 near the obstacle shape and the obstacle shape 3306, it is made possible to facilitate visual checkup of the set state of the space weight near the obstacle shape. In the case illustrated in FIG. 33, the obstacle shape is shown in black, display setting with a high weight coefficient is shown in white in terms of gradation, and display setting with a low weight coefficient is shown in black.

To add, while the route shape is generated after the scholar field is generated with the routing difficulty level calculating function 104 in the foregoing embodiment, it is also acceptable for the piping or wiring support device to generate a scalar field in advance, structure a scalar field database in advance, and to cause the route shape generating function 105 to generate by itself the route shape by using that scalar field data. It would be thereby made possible to provide assist arrangement designing of items for arrangement with computerized arrangement processing, and thereby to reduce the workload on the operator and support his or her designing task.

Also, even if the route shape generating function 105 is not used but arrangement is to be manually designed, the piping or wiring support device may as well use the routing difficulty level calculating function 104 alone that generates and displays a scalar field. Scalar field designing may also be assisted according to arrangement rules.

Further, the scalar field database 110 may be structured in advance by using the routing difficulty level calculating function 104 or by manual work, and the piping or wiring support device may rely on the interface function 103 alone (or the output function alone) without using the route shape generating function 105. In this way, arrangement designing can be assisted visually.

To add, the present invention is not confined to the embodiment or detailed examples described above, but many modifications may be include. For instance, the foregoing embodiment was described in detail for easier understanding, but need not have the whole configuration stated therein. Also, part of a given configuration of the embodiment may be replaced with the configuration of another embodiment, or the configuration of another embodiment may as well be added to a given embodiment. Further, it is possible to add, delete or replace another configuration to, from or with part of each embodiment.

Further, the configurations, functions, processing units, processing means and the like described above may be partly or wholly realized with hardware by, for instance, designing them in integrated circuitry. Also, the configurations, functions, processors, processing means and the like described above may be partly or wholly realized with software by having the processor of the computer interpret and execute the individual functions. The programs, tables, files and information measurement information and calculated information can be placed in recording devices such as memories, hard disks and/or SSDs (Solid State Drives) or on recoding media such as IC cards, SD cards and/or DVDs. Therefore, the individual processing, configurations, functions, processors, processing means and the like can be realized as processors, processing units and/or program modules.

Further, only those control lines or information lines necessary for description are referenced, but not all the control lines or information lines necessary for products are necessarily referred to. In practice, it may be considered almost all the configurative elements are connected to one another.

### INDUSTRIAL APPLICABILITY

The invention can be utilized for route shape designing for piping or wiring using CADs.

### LIST OF REFERENCE SIGNS

101 . . . input unit
102 . . . Display unit
103 . . . Interface function
104 . . . Routing difficulty level calculating function
105 . . . Route shape generating function
106 . . . Obstacle shape database
107 . . . Route start point/end point database
108 . . . Route passing point sequence database
109 . . . Route search space parameter database
110 . . . Scalar field database
201 . . . Layout condition database
202 . . . Layout condition common parameter database
203 . . . Layout condition individual parameter database
204 . . . Layout condition generating means
205 . . . Scalar field generating means
301 . . . End point distance field database
302 . . . End point distance field generating means
303 . . . Route point sequence generating means
401 . . . Common parameter editing means
402 . . . Layout condition parameter editing means
1401 . . . Layout condition individual parameters
1601 . . . Layout condition generation parameter database
1602 . . . Layout condition generation parameter acquiring unit
1603 . . . Obstacle distance field calculating unit
1604 . . . Weight table calculating unit
2101 . . . Route search space discretizing unit
2102 . . . Space weight registration unit
2401 . . . End point distance field initializing unit
2402 . . . End point distance calculating unit
2701 . . . Distance field gradients searching unit
2702 . . . Route shape adjusting unit
3001 . . . Common parameter editing unit
3002 . . . Route search space preview display unit
3101 . . . Common parameter editing frame
3102 . . . Route search space resolution input field
3103 . . . Common influence range adjusting slider
3104 . . . Common weight coefficient adjusting slider
3105 . . . Route search space display frame
3106 . . . Route shape
3107, 3306 . . . Obstacle shape
3108 . . . Weight of space
3109 . . . Cursor
3201 . . . Layout condition parameter editing unit
3202 . . . Layout condition preview display unit
3301 . . . Layout condition parameter editing frame
3302 . . . Layout condition resolution input field
3303 . . . Individual influence range adjusting slider
3304 . . . Individual weight coefficient adjusting slider
3305 . . . Layout condition preview frame
3307 . . . Nearby space weight

1. A piping or wiring support device comprising route search space parameter memory means that holds magnitudes of route search spaces in piping or wiring is to be laid and route search space parameters representing discretizing resolution; scalar field memory means that holds space weight information representing a routing difficulty level in a route search space; obstacle shape memory means that holds shape data avoided by route shapes in the route search space; route start point/end point memory means that concerns start point and end point coordinates of a route; route passing point sequence memory means that holds coordinates of a route passing point sequence linking between route start point and end point, the device further having a routing difficulty level calculating function to output a scalar field, which is space weight information numerically representing the difficulty level of routing that the obstacle shape of the obstacle shape memory means imposes the route search space of the route search space parameter memory means; and a route shape generating function that uses the outputted scalar field to figure out the route shape in the route search space of the route start point/end point memory means from the start point to the endpoint of the route and outputs the route passing point sequence of the route.

2. The piping or wiring support device according to claim 1, wherein the routing difficulty level calculating function is a function to numerically express the routing difficulty level in the route search space and has layout condition common parameter memory means to hold layout condition common parameters, which are space weight control parameters common to all obstacle shapes; layout condition individual parameter memory means to hold space weight control parameters of individual obstacle shapes; layout condition memory means to hold layout conditions, which constitute nearby space weight information on each individual obstacle shape; layout condition generating means to calculate layout conditions and register the conditions with the layout condition memory means; and scalar field generating means to calculate weights of space in the whole route search space area by using layout conditions.

3. The piping or wiring support device according to claim 1, wherein the route shape generating function is a function to figure out the route passing point sequence linking the route start point and endpoint by using the space weight information acquired from the scalar field memory means, and has end point distance field memory means to hold a distance field having the route end point in the route search space as the reference position; end point distance field generating means to calculate an end point distance field while taking account of the weight of space held by the scalar field; and route point sequence generating means to calculate the route passing point sequence linking the route start point and the route end point by tracing a gradient from the route start point to the end point distance field.

4. The piping or wiring support device according to claim 1, wherein an interface function is an editing function to enable a user to route search space parameters, layout common parameters and layout condition individual parameters, and provided with common parameter editing means to edit route search space parameters; and common layout condition parameters by using a graphical user interface and layout condition parameter editing means to edit the layout condition parameters by using a user interface,

5. The piping or wiring support device according to claim 2 having the routing difficulty level calculating function wherein the layout conditions recorded in the layout condition memory means are memory means holding the distance field in the nearby space of the obstacle shape and the weight information on nearby spaces holds in combination layout condition IDs each capable of identifying each individual layout conditions, an obstacle distance field to hold distances from the surfaces of obstacle shapes in spaces near the obstacle shapes, and a weight table, which is numerical value array data representing numerical values weights of space according to the distance.

6. The piping or wiring support device according to claim 2 having the routing difficulty level calculating function wherein the layout condition generating means is means to generate and edit layout conditions for individual obstacle shapes, and has a layout condition generation parameters acquiring unit that generates layout condition generation parameters by synthesizing the layout condition generation parameters holding square measures of spaces near individual obstacle shapes and space weight information for use in the generation of layout conditions; an obstacle distance field calculating unit that calculates distance field in spaces near individual obstacle shapes; and a weight table calculating unit that tabulates weight values in the spaces near the individual obstacle shape by using the layout condition generation parameters.

7. The piping or wiring support device according to claim 1, wherein scalar fields on record in the scalar field memory means has a data structure of discretizing the route search space using cubes holding scalar values and has a three-dimensional array of cubes whose dimensions are the widthwise direction, depth direction and height direction, reference coordinates, which the reference positions of volume data and the numbers of cube division in the dimensional directions of width, depth and height.

8. The piping or wiring support device according to claim 1, wherein route search space parameters have a rectangular parallelepiped area containing the route start point and end point and have a search space resolution, which represents the size of the cube for discretizing the rectangular parallelepiped area.

9. The piping or wiring support device according to claim 2 in whose routing difficulty level calculating function, the scalar field generating means has a route search space discretizing unit that generates scalar fields by discretizing with cubes the rectangular parallelepiped area acquired from route search space parameters; and a space weight registration unit that registers space weights of nearby obstacle shapes acquired from the layout condition memory means with the scalar field.

10. The piping or wiring support device according to claim 2 in whose routing difficulty level calculating function, the layout condition common parameters have a common influence range which is a parameter for collective control of the magnitude of spaces near obstacle shapes in all the layout conditions and a common weight coefficient which is a parameter for collective control of the space weights in all the layout conditions.

11. The piping or wiring support device according to claim 2 in whose routing difficulty level calculating function, layout condition individual parameters have layout condition IDs capable of uniquely associating layout conditions, a layout condition resolution is the sizes of cubes to discretize spaces near individual obstacle shapes, a weight function expressed in a space weight numerical formula, individual influence ranges which are sizes of space near individual obstacle shapes, and an individual weight coefficient which is the intensity of the weight function.

12. The piping or wiring support device according to claim 3 in whose route shape generating function, the end point distance field generating means is means to generate information on distances from the route start point in the route search space, and has an end point distance field initializing unit that discretizes the route search space with cubes; and an end point distance calculating unit that calculates information on the distance from the route end point to any random position in the route search space and registers it with the end point distance field.

13. The piping or wiring support device according to claim 3 in whose route shape generating function, the route point sequence generating means generates a route linking the route start point and the route end point by tracing end point gradients of distance fields from the route start point.

14. The piping or wiring support device according to claim 4 in whose interface function, the common parameter editing means has a common parameter editing unit that is a user interface for editing the route search space parameters and the layout condition parameters; and a route search space preview unit that is a display means for duplicate displaying of scalar fields and the route passing point sequence.

15. The piping or wiring support device according to claim 4 in whose interface function, the layout condition parameter editing means has a layout condition parameter editing unit that edits the layout condition individual parameters with respect to each individual layout condition; and a layout condition preview display unit that previews spaces near individual obstacle shapes and space weights.

16. The piping or wiring support device according to claim 1 in whose obstacle shape memory means, each individual obstacle shape is formed of a shape data ID, which is a name permitting unique identification, and a three-dimensional shape whose external space and internal space are distinguishable from each other.

17. A piping or wiring support device having a route search space parameter memory means holding positional information of a route search space in which piping or wiring is to be accomplished; a scalar field memory means holding space weight information representing the routing difficulty level in the route search space; and an obstacle shape memory means holding shape data to be avoided by a route shape in the route search space, wherein an output function is provided to display the route search space of the route search space parameter memory means, display the obstacle shape of the obstacle shape memory means, and display a scalar field, which is information on the space weight numerally expressing the difficulty level of routing caused by the obstacle shape of the obstacle shape memory means to the route search space of the route search space parameter memory means.

18. The piping or wiring support device according to claim 17, further having a route start point/end point memory means for coordinates of the start point/end point of a route; and a route passing point sequence memory means to hold coordinates of the passing points linking the route start point and end point, wherein an output function is provided to display, superposed over the displayed scalar field, a route shape which is a polygonal line figure linking the start point, the route passing point, and the end point.

19. The piping or wiring support device according to claim 17, further having an output function to display a common influence range adjusting slider that alters the influence range of the weight of space and, after having adjusted the common influence range adjusting slider, to display in an interlocked manner a state in which the distance from an obstacle shape to the external edge of a nearby space weight is altered.

20. The piping or wiring support device according to claim 17, further having an output function to display a common weight coefficient adjusting slider that alters the weight of space and, after having adjusted the common weight coefficient adjusting slider, to display in an interlocked manner a state in which the displayed state of the space weight from an obstacle shape to the external edge of a nearby space weight.
